(19) United States
(12) Patent Application Publication
(10) Pub. No.: US 2012/0166338 A1
(43) Pub. Date: Jun. 28, 2012

(54) METHOD AND SYSTEM FOR UNIVERSAL APPLICATION FOR TRANSACTION PROCEDURES WITH NFC TECHNOLOGY

(76) Inventors: Paolo Osvaldo Agnelli, Milano (IT); Stefano Giuseppe Lambertini, Monza (IT); Riccardo Melen, Milano (IT); Giancarlo Reschigna Venturini, Milano (IT)

(21) Appl. No.: 13/390,830

(22) PCT Filed: Aug. 13, 2010
(86) PCT No.: PCT/EP2010/061847

§ 371 Date: Mar. 9, 2012

(30) Foreign Application Priority Data
Aug. 18, 2009 (IT) MI2009A001488

(51) Int. Cl. G06Q 20/32; H04B 5/00; G06Q 20/40

(52) U.S. Cl. 705/44

(57) ABSTRACT

The present invention relates to a method and a system for a universal application for transaction procedures with NFC technology. This application allows to realize an application distribution network for accessing services by means of mobile terminals provided with a proximity wireless communication technology or “proximity based communication protocol” (e.g. NFC, Bluetooth, RFID). The present invention envisages a “universal” mobile application, which is capable of modifying its function for each real application used, in terms of process and user interface (or “user experience”), e.g. menu layout, colors, logos, functionalities, commands.

### FIELD OF THE INVENTION

The present invention relates to a method and system for carrying out a transaction (e.g. payments) by means of mobile devices, more particularly to a method and system for realizing an application distribution network for accessing services by means of mobile terminals provided with a proximity wireless communication technology or “proximity based communication protocol” (e.g. NFC, Bluetooth, RFID).

### BACKGROUND OF THE INVENTION

The spreading of instantaneous methods of payment without use of cash (e.g. credit cards, bank cards and others) is constantly increasing, but it encounters some difficulty to assert itself in the payments of small sums because of the cost relatively high of the transaction with respect to the value of the same and to the payment procedure complexity.

The attempts to simplify such procedures must deal with safety and reliability requirements connected with data transmission.

The Near Field Communication (NFC) technology is a wireless, bidirectional, short range radio frequency (RF) communication technology; see, for example, the Information Society Technologies (IST) program of the European Commission, which refers to the field defined in “NFC Application and Business Model of the Ecosystem” (“Mobile and Wireless Communications Summit, 2007, 16th IST” conference proceedings, IEEE 9795461, ISBN 963/8111/66/6), which describe the purposes of the pan-European consortium StoLPaN (Store Logistics and Payment with NFC), co-established by the European Commission (EU) and composed of companies, universities and user groups (EU, FP6 work programme, ICT area for Enterprise Networking, project cluster: Ambient Intelligence technologies for the Product Lifecycle, ftp://ftp.cordis.europa.eu/pub/ist/docs/directorated/ebusiness/stolpan.pdf). The NFC technology allows two close devices to exchange data in a simple, safe and bidirectional way. The NFC technology is a result of the combination of two technologies: Contactless (ISO 14443) and Mobile (GSM), which has developed from simple passive communication, that is contactless identification or RFID (Radio Frequency Identification), up to active communication mode, that is interconnection technologies. Therefore, the NFC technology allows a read/write communication between two elements. This means that when two NFC systems (Initiator and Target) are situated close to each other, a peer-to-peer network between the devices is created and both devices can send and receive information at the same time, interacting in the two directions. The NFC technology works at 13.56 MHz RF frequency, within a range of 0 to about 10 centimeters. The technical specifications of the NFC technology are based on protocols ISO4 15693, 18092 and 21481, ECMA5 340, 352 and 356 and ETSI6 TS 102 190. Moreover, it is compatible with the common architecture of the contactless smart card, based on the ISO4 14443 A/B, Philips MIFARE and Sony FeliCa. At present, the NFC has all the necessary requirements to be accepted also effectively by industrial associations, service suppliers and users. Actually, it has been defined as a safe reference standard and universally accepted by the European Bank System (SEPA directions—Shared European Payment Area); moreover, the GSM association has set it to be the standard for the RFID TAG embedded in mobile phones.

With respect to a possible use/spreading of services for data authentication/access/exchange, based on protocols universally accepted as safe (NFC forum, GSM association, SEPA) the current state of the art proposes a situation in which each service provider must proceed with a use specification project and realize a specific client for mobile terminals (application resident on the mobile terminal), an NFC server (that is counter-part application residing in the service distribution system, also known as Totem) and an application communication protocol between the developed components. This approach can be distractive in terms of resources and investments: actually, it is reasonable to think that the project technical equipment for setting up a ticketing system has considerable common points with that for an access system project e.g. a vending machine or a paying car park.

The possibility of finding common elements abstracting from the specific case and allowing to create a structure for use processes beginning from a common base (proposed framework) would allow to reduce general costs and times due to a possible adoption of the NFC as services access technology.

### OBJECT OF THE INVENTION

An object of the present invention is to alleviate at least some of the problems associated with the prior art systems.

According to one aspect of the present invention there is provided a method for carrying out electronic transactions by means of client mobile devices capable of establishing communications with a plurality of server devices through a first at least one proximity wireless communication channel, each client mobile device being associated with certified identification means, each server device being associated to the supply of at least one service or good, the method being characterised by the steps of: detecting the presence of a client mobile device, within a predetermined communication distance from a server device of said plurality of server devices; establishing a secure communication session for carrying out transactions between the client mobile device and the server device; responsive to the server device authenticating the identity of the client mobile device by means of data associated to the certified identification means, downloading one or more software modules of a software application from the server device to the client mobile device, the application being adapted to handle the supply of the at least one service or good associated to the server device; running the software application on the client mobile device, thereby providing the client mobile device user with an interface, by which the supply of the service or good associated to the server device can be requested.

Advantageously, the first proximity wireless communication channel includes a NFC protocol based channel.

Furthermore, advantageously, the mobile terminals and servers are adapted to communicate with each other through a great capacity channel aimed at exchanging data (e.g. Bluetooth, RFID, WiFi, GSM/GPRS/UMTS) and the download connection occurs through one of these channels.

According to a possible embodiment of the present invention, the server is connected, via a communication network, to a remote server (e.g. a backoffice), to which the mobile terminal authentication requests are sent.

According to a further advantageous embodiment of the present invention, the identification means include the reference to a credit card or other payment cards.

According to the present invention, there is also provided a mobile terminal adapted for carrying out the above described method. Likewise, a server adapted for cooperating with the mobile terminal is provided.

According to the present invention, we provide a computer program, a software application or a program product which implement the above method, when run on a computer, a telephone or any apparatus capable of data processing.

Moreover, a distributed system implementing the above method is provided.

With the present invention it is possible to create a universal application system for transaction procedures with NFC technology (or another proximity wireless communication technology); the system allows distribution of access applications for goods or services as support of a micropayments network, which exploits the NFC technology in order to put in contact mobile terminals (e.g. mobile telephones) with the service providers (e.g. automatic distributors, toll or parking machines, controlled access to public means or places, domotics systems). The system is based on a typical Client-server architecture, in which the client devices (e.g. NFC mobile phones) do not need being previously provided with the software necessary to communicate with various Servers: a universal module, called NFC Alias, has the function of interfacing with the servers enabled to the same service and downloading the application necessary to interact with the server system on the client terminal. One of the advantages of using the NFC technology for communication between Client and Server derives from the fact that this technology beside being safe, as explained before, is obtaining a wider and wider diffusion in common mobile phones. Therefore, users who have such NFC telephones will not need ad hoc apparatuses, but they will be able to use their own existing terminals, by simply installing the universal NFC module. Likewise, the advantage for the providers lies in the fact that they will be able to develop their software package on the basis of the NFC Alias protocol simple rules, since they can rely on a high number of potential clients to whom they will transfer the necessary software only when it is needed.

### BRIEF DESCRIPTION OF DRAWINGS

Reference will now be made, by way of example, to the accompanying drawings, in which:

FIG. 1 illustrates the general architecture of a system according to a preferred embodiment of the present invention;

FIG. 2 illustrates schematically a generic computer used in the system according to a preferred embodiment of the present invention;

FIG. 3 illustrates schematically the modules which constitute the system according to a preferred embodiment of the present invention;

FIG. 4 illustrates a sequence of activities for activating the service according to a preferred embodiment of the present invention;

FIG. 5 illustrates the detailed structure of the NFC Alias system (both for the client component and the server component),

FIG. 6 illustrates schematically the main software components of the NFC Alias Loader;

FIG. 7 illustrates schematically the communication modes between the NFC Alias Loader and the Backoffice, according to a preferred embodiment of the present invention;

FIGS. 8 to 13 illustrate application examples of the present invention;

FIG. 14 illustrates schematically the steps of a method according to a preferred embodiment of the present invention.

### DETAILED DESCRIPTION OF THE EMBODIMENTS

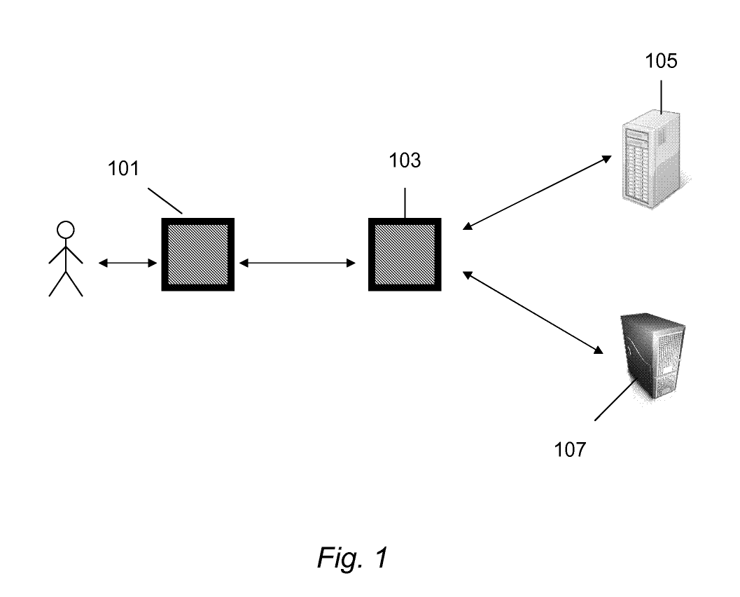

As it is shown schematically in FIG. 1, the architecture according to a preferred embodiment of the present invention includes a universal client module 101, which allows access to the user by means of an interface (e.g. the usual interface of a mobile phone, on which the client module 101 is installed). The main architecture requirement is the adaptivity of the universal client (called NFC Alias Loader or even simply Loader) to the characteristics of the real use case and the use optimization of the available resources. The NFC Alias Loader universal client will be installed previously on each terminal, so as to load, each time, the specific client/service-application. The NFC Alias Loader will incorporate the architecture principles of reflexivity and being multichannel: optimal operation requires the knowledge of the environment in which it is both in terms of the configuration and of the operational situation and the available communication channels. The ‘counter-part’ of the universal client is composed of a ‘universal server’ application 103, likewise flexible, that is present in a plurality of systems connected to one or more distributor of services or goods (e.g. “vending machine”, automatic distributors, toll collectors, ticket emitters) which implements the “embedded” server function (think, for example, about the embedded interface/controller of a vending machine) in a low cost way and easy to maintain. The universal server 103 acts mainly as proxy, stub-passthrough toward local interfaces 107 for the communication between the application loaded on the universal client and the actuators for local operation commands (e.g. vending machine which has to physically deliver goods).

The universal server 103 will be able to be connected also to a remote Backoffice 105, e.g. an information system, as in those cases in which the supply of the required service or goods is handled by a third party in a remote mode (e.g. a transport corporation central system for issue of a ticket valid in its network). The connections of the universal server module 103 with a local interface 107 or with a backoffice 105 have been described as an alternative, however they can be both present at the same time. For example, the universal server can act locally as a direct control system of actuators for local supply of goods (e.g. beverage distributors) by means of a local interface 107, while, at the same time, the remote connection with the backoffice 105 can be used for recording performed actions and/or transactions carried out, for example, to record the charge on the current account (e.g. registration of charge for goods and/or services supply). According to a preferred implementation of the present invention, the terminal, on which the universal client is installed, is typically a CLDC type (JSR 139, CLDC 1. 1-JSR 118, MIDP 2.0), while the server can be also, preferably, a CDC type apparatus (JSR 210, CDC 1. 1. 2). The CDC or CLDC classification refers to a standard classification that can be found, for example, at the following url http://jcp.org/en/jsr/overview. This scheme puts together the devices according to elaborative capacity classes and use characteristics: for example, the common mobile phones belong to the CLDC category, which ensure a series of limited functionalities, while the palmtops or laptops belong generally to the CDC category with more complex functionalities. An important aspect of the present invention derives from the fact that the functionalities and the interface made available to the final user must be simplified enough to take into consideration the more reduced functionalities of the portable terminals available to the user (as previously said, the common mobile phones belong to the CLDC category). In this way, it is possible to widen the potential customer base without forcing the users to procure ad hoc apparatus. For better economy of industrialization and maintenance costs in the ‘real world’, the server 103 reference capabilities can be referred to those of the loader 101; otherwise, an apparatus with more advanced functionalities (i.e. of CDC category, according to the present example) can be used for the server 103. According to a preferred embodiment of the present invention, the universal client 101 is installed on the portable terminal equipped with an NFC transmitter, as for example, the Nokia 6212 classic model; other possible terminals include for example, Nokia 6131 NFC, BenQ T80, Motorola L7(SLVR) NFC, Samsung SGH-D500E NFC, Samsung SGH-X700n (brick) NFC, Sagem-Orga my700X NFC, Nokia 3220+NFC Shell), while the universal server 103 is implemented by means of any server equipped with a NFC transceiver; it can also be a normal server or computer available on the market, to which, for example, an RFID NFC antenna/reader with serial connection RS232 or USB can be added, as for example the OEM readers based on PN53x components of NXP Semiconductor (Philips), the OEM readers for industrial environments of Arygon Gmbh, or mass-market models such as desktop readers of Arygon Gmbh or the ACR122-NFC reader of Futako Ltd. It is also possible, as it will be better shown later on, for the sake of costs efficiency and project uniformity, to use for the server side a portable terminal, equipped with the NFC transmitter identical with those used for the client.

According to a preferred embodiment of the present invention, the universal client 101 and the server application 103 are capable of operating on a sufficiently wide group of mobile models, so as to rely on a wide base already installed. The reference target is the J2ME, having a capability equal to or greater than the JSR 139 (CLDC 1.1)-JSR 118 (MIDP 2.0), and the client and the server are preferably designed so as to reduce as much as possible the memory and processing capacity requirements necessary for operation. The availability of the NFC technology is a requirement of the used mobile terminal while the presence of other wireless communication supports (typically Bluetooth, WiFi) and the covering of the corresponding network can be necessary or optional, according to the application environments. A device is provided which allows the client and server to be dynamically aware of the capability of the environment in which they are. According to a preferred embodiment of the present invention, the communication protocol being used is based on NFC technology; however, those skilled in the art will appreciate that different wireless communication protocols or modes can be used alternatively, as long as they meet the reliability and safety requirements set by the specific cases. For example, in case the safety level required by the specific implementation in not very high, less safe transmission modes can be used, e.g. bluetooth or GPRS. Generally, after the initial negotiation step between the universal client and the universal server via NFC, a bluetooth channel can be opened to allow the interaction between the client and server. In this way, faster channels can be used for application downloading, exploiting the wider range of bluetooth channel with respect to NFC. Another possible advantage deriving from the use of bluetooth transmission with respect to NFC is its transmission distance, remarkably higher than that of NFC, so that, once the connection has been created through the certified channel NFD, the same mobile terminal can operate also at longer distances, e.g. for command exchange in the field of domotics: the user handheld phone is brought into close proximity with the embedded server in the domotics control system, the alternative bluetooth channel is created and the telephone can then be used as a handheld remote pilot for the domotics systems connected to the server up to the maximum distance that the bluetooth technology allows (about 10 mts with respect to few centimeters by NFC).

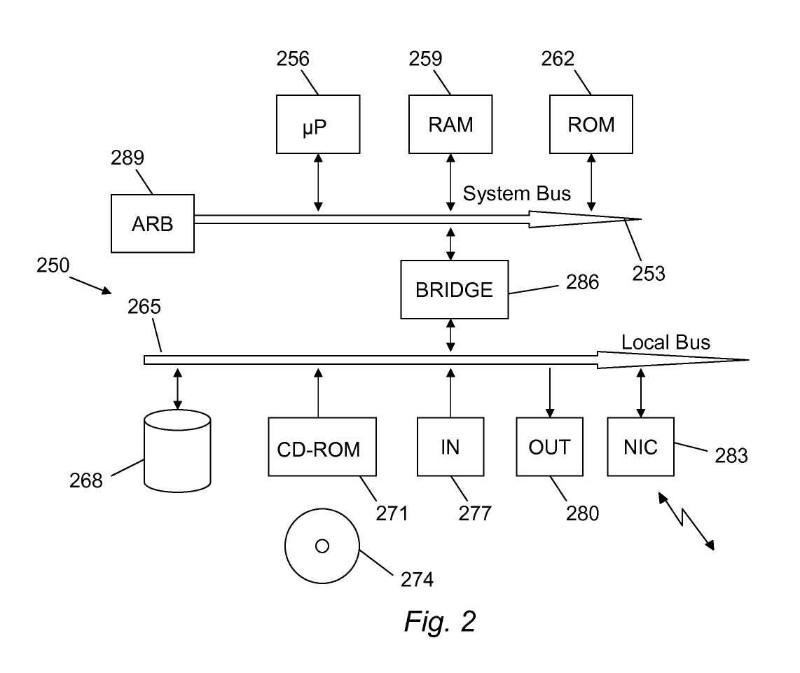

FIG. 2 illustrates a generic computer used in the system according to a preferred embodiment of the present invention. Such generic description includes any apparatus provided with processing capabilities, even with different sophistication and functionality levels (e.g. computers, mobile terminals, servers, network routers, server proxies). Computer 250 includes different units, which are parallel connected to a system bus 253. In details, one or more microprocessors 256 control the computer operation; a RAM memory 259 is used directly by the microprocessors 256 as process memory, while a ROM memory 262 holds the basic code for the system initial loading operation (bootstrap). Various peripheral units are connected to a local bus 265 by means of suitable interfaces. In particular these peripheral units may include a mass memory formed by hard disk 271 and a CD-ROM and optical disk driver (e.g. DVD or BlueRay) 274. Moreover, the computer 250 may include input devices 277 (e.g. a keyboard, a mouse, a track point) and output devices 280 (e.g. a screen, a printer). A network card (Network Interface Card) 283 is used to connect the computer 250 to a network. A bridge unit 286 forms an interface between the system bus 253 and the local bus 265. Each microprocessor 256 and the bridge unit 286 may operate as “master agent” and request exclusive access to the system bus 253 for information transmission. An Arbiter 289 manages the access requests to the system bus 253, avoiding conflicts between the requesters. Similar remarks applies to slightly different systems or to systems based on differently configured networks. Other components, beside those described, can be present in specific cases and for particular implementations (e.g. palmtop computers, handheld phones etc).

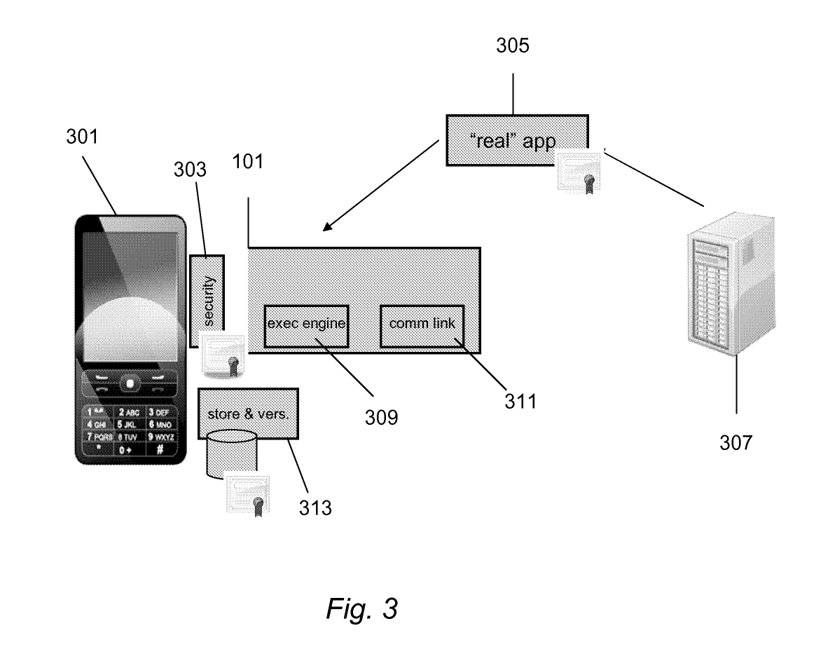

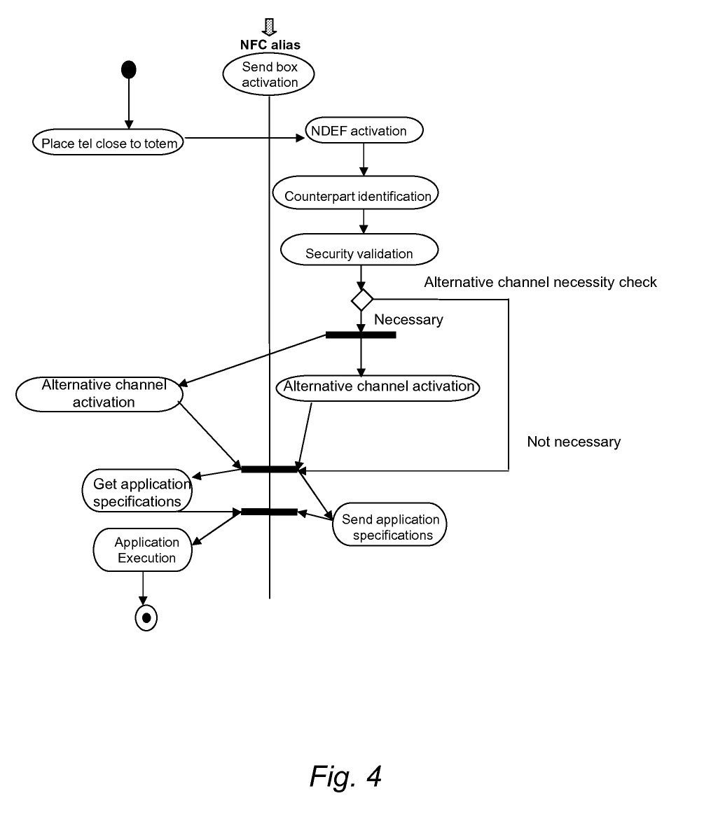

As previously mentioned, the universal software package NFC Alias, intended as a whole formed by the universal client module 101 (or Loader or even simply client) and by the universal server application 103 (or simply server), is a system to create an application distribution network for accessing services (or goods) in which each real application being used can present its function to the user in term of process and user experience (menu lay out, menus, colors, logos, functionalities, etc.). As schematically shown in FIG. 3, the user has a certified and signed “object” on his mobile phone 301, the universal client (Loader NFC Alias) 101, which he can trust, which establishes a connection via the universal server 103 (see FIG. 1), preferably embedded in the totem-distributor 307, when the totem-distributor 307 is approached by the mobile phone 301; according to a preferred embodiment of the present invention, this connection is made through the NFC proximity communication protocol. Once the connection has been established, an application 305 is downloaded from server 307 to handheld terminal 301, in a way transparent to the user. The download takes place through the communication manager sub-system 311 and involves loading on the mobile terminal 301 the software necessary for running the application linked to the server 307, including real service description and parameters (e.g. supply of goods or services). According to a preferred embodiment of the present invention, application 305 is stored in a memory area of server 307, but in a possible alternative implementation the application can be held in a remote database, to which server 307 can connect via a network. As previously mentioned, application download (i.e. the data transmission from server 307 to the mobile terminal 301) can take place through a transmission channel other than that with which the initial connection was established, for example, via a bluetooth transmission. The downloaded application is stored in memory 313 to be used thereafter. Execution of this application, by means of execution module 309, can provide the user with a series of information details allowing the use of the service, by means of e.g. a use process, an interaction, logos, prices and specific predefined conditions. According to a preferred embodiment of the present invention, the client is digitally signed with an “operator” or “manufacturer” class certificate, checked and verified by the safety manager sub-system 303 which controls the operations together with the communication sub-system 311, the execution sub-system 309 and the local storing sub-system 313, in which the real application 305 is saved, coded with the above mentioned digital signature (digital coding). Downloading and storing more than one real application 305 might also be possible, with the only limit of the mobile terminal technical features (e.g. size of memory 313). Another possible embodiment of the present invention envisages that only some modules of application 305 are downloaded from server 307, in that the application basic structure can already be available on the mobile terminal 301. The system modular architecture allows different standard levels, which may improve performances and speed up the installation steps of the software application 305: for example a group of different applications on different server systems could have common interface elements with repeated commands, permitting a strong limitation of the specific instruction set requested for each single application and related service or good. In such case, the quantity of data to be transferred during the communication between the universal client and universal server requires a more limited transmission band and the reduced range of the NFC channel does not constitute an obstacle. Using the schematic layout of the UML diagrams, FIG. 4 shows the activity frequency of a possible implementation of the method in accordance with a preferred embodiment of the present invention. Activation of NFC alias on the mobile terminal encompasses activation of the client application, which is waiting for an identification of a counter-part (the server) capable of communicating therewith, when in communication range, identifying itself and passing on the look of interface.

When the interface look is transmitted, some technical steps have a specific importance.

The amount of data in byte (dimension) of the real application and semblance to be put on (i.e. the interface) depend on the application that the server passes on to the user handheld mobile terminal, but also on logos, images and texts, which could be associated thereto. With dimensions over a predetermined threshold (e.g. about 50 KByte), the proximity channel transmission capability can be a limit, which compels the user with the mobile terminal to stay close to the server for several seconds. As mentioned above, to overcome this possible drawback, the client and server may negotiate the use of an alternative more powerful communication channel, amongst those made available by the user mobile terminal (and server) hardware and managed by the client.

More powerful alternative communication channels includes Bluetooth, WiFi and GSM/GPRS/U MTS.

In accordance with a preferred embodiment of the present invention, when the user telephone enters the detection range of the totem/system/apparatus in which the server is embedded, the proximity basic technology automatically enables a communication channel called NDEF.

At this point, the NFC alias, considered in its two components client and server, one on the user telephone and another on the server, negotiates secure recognition of the counter-part, verifies the necessity of activating a more powerful alternative communication channel and starts sending the application look (interface) which the user telephone client must adopt.

Once the specific application look has been received, the client executes it and, again, if the look requires interaction with the server at a distance greater than the proximity range, it can open an alternative communication channel to communicate therewith and allow the user to interact through the server with local actuators (for example a coffee making machine) with a remote information system (for example purchasing a train ticket: I ask for scheduled times and select a train).

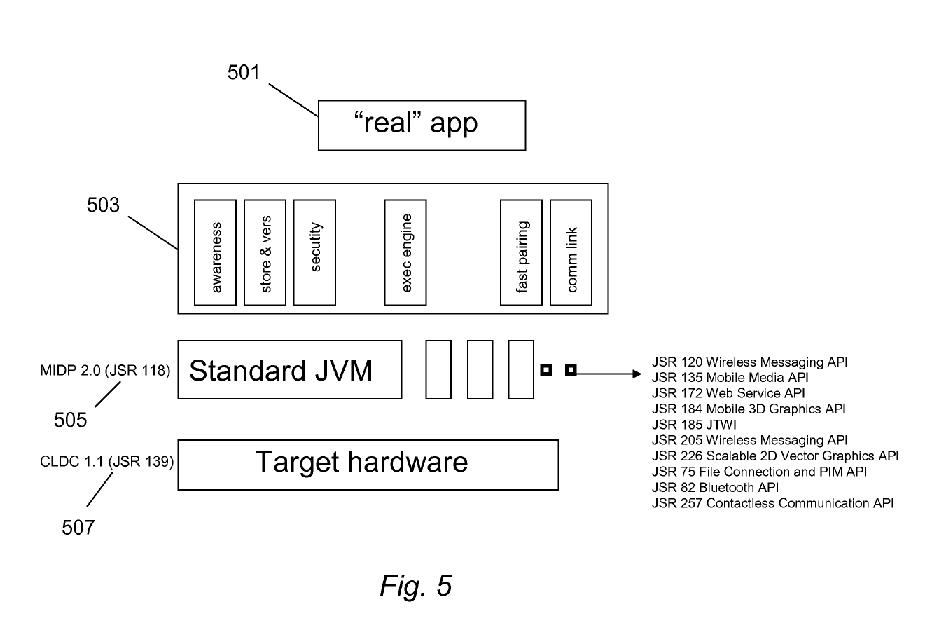

In accordance with a preferred embodiment of the present invention, both the client and the server are Java language software applications consistent with the syntactic specifications of the Java language, in particular those relating to mobile and palmtop terminal categories, known as J2ME (for references on Java language in general and on J2ME specifications in particular, see www.jcp.org). As shown in FIG. 5, the NFC Alias (as far as both its client and server components are concerned) can be represented as an application executed within the Java Virtual Machine (JVM standard 505 present in the target system 507) and organized as a specific components and libraries logic of the implementation herein described: NFC Alias technical components 503 are present, amongst which, for example: environment, awareness, communication link, execution engine, safety. The real application 501 is adapted to use the underlying levels and libraries.

The requirements necessary for NFC Alias execution are the presence of a Java Virtual Machine, which is often pre-installed by the manufacturer of hardware supports, which include e.g. a mobile phone adapted to NFC communication for the client and an embedded application terminal or a second mobile phone for the server.

With reference to industrial standard details present on www.jcp.org, in accordance with a preferred embodiment of the present invention, the Java Virtual Machine must: comply with the Java standard; comply with the J2ME mobile application syntactic specifications, with the specifications for technological environment JSR 139 CLDC 1.1 (or higher such as e.g. JSR 218 CDC 1.1.2 and JSR 118 MIDP 2.0); and must make available or allowing installation of the following standard software libraries:
JSR 120 Wireless Messaging API
JSR 135 Mobile Media API
JSR 172 Web Services API
JSR 184 Mobile 3D Graphics API
JSR 185 JTWI
JSR 205 Wireless Messaging API
JSR 226 Scalable 2D Vector Graphics API
JSR 75 FileConnection and PIM API
JSR 82 Bluetooth API
To which the following can be added as optional requirement:
JSR 257 Contactless Communication API

Typically, the client is installed on a CLDC (JSR 139, CLDC 1.1-JSR 118, MIDP 2.0) category terminal while the server can preferably be also a CDC (JSR 218, CDC 1.1.2). For design and operation/maintenance economy reasons, in ‘real world’ reference to the technological environment and category specifications can be the same as those of the client (i.e. for both the minimum CLDC specifications apply).

In accordance with a preferred embodiment of the present invention, both the client and the server are applications substantially formed by the same application components, arranged in accordance with different relationship layouts. This arrangement allows controlling of code and technical interfaces proliferation, while the system homogeneity is maintained as long as possible.

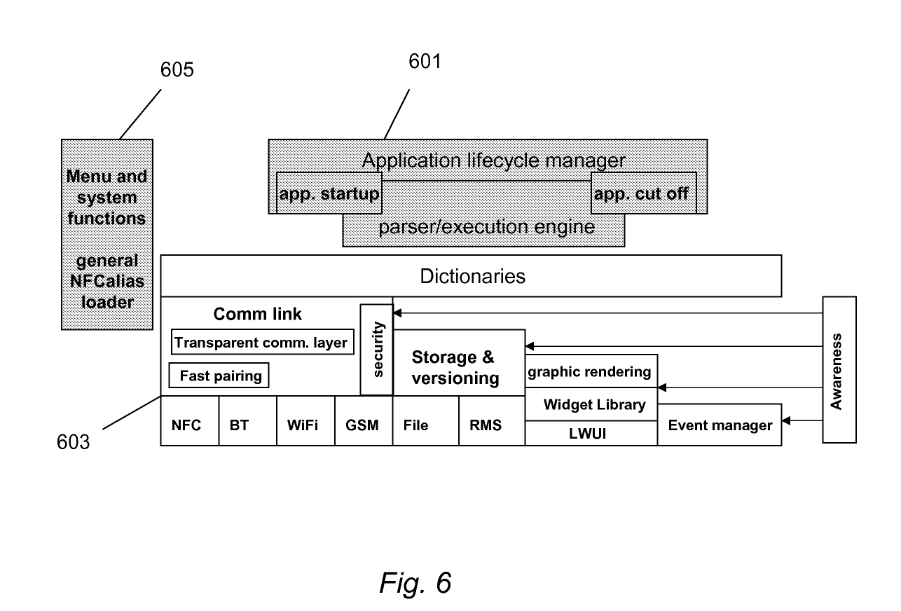

FIG. 6 shows schematically the composition of the NFC Alias client (Loader) and its main modules, in accordance with a preferred embodiment of the present invention. The client has its own ‘system’ menu 605 for the ‘basic’ configuration (e.g. user identity), verification of the present applications and possibly their manual activation. It also includes an Application Lifecycle manager module 601 with all the initialization functions, (general calls, awareness activation, dictionary compilation and capabilities matching). As for the actual executive part, the NFC Alias technical components main libraries 603 included in the client, in accordance with the preferred embodiment, are: awareness, storing and versioning, communication link management (and fast pairing), parser and execution engine, safety, graphic rendering and event manager. The most important module is the execution engine, which is capable of real applications execution and communication (with the server, with the backoffice and local proxies).

Another important element of the execution engine includes the dictionaries, which represent the entire namespace of the possible executive actions by the parser (they are present in the technical form of function pointer arrays). The content of the dictionaries is previously defined in the namespace and parser/execution engine design step, and includes all the actions, with the related capabilities, which are allowed for the applications. Every dictionary element has general attributes, the elements can be either static or dynamic. The static elements are considered strictly mandatory for correct operation of NFC Alias, and the dynamic elements are considered non strictly mandatory for correct operation of NFC Alias (definition of static and dynamic can change in accordance with the implementation requirements).

The case list of the elements found in the dictionaries is:

| element of | | |
|---|---|---|
| dictionary | presence | |
| static | verified “by | e.g. some graphic |
| | design” | primitives |
| static | to be verified | absence generate |
| | in awareness | exception and terminates |
| | step | NFC Alias |
| dynamic | to be verified | absence predisposes to |
| | in awareness | a ‘dummy’ execution with |
| | step | default return values |

The ‘Call’ by the parser/execution engine of an element which is not present in the dictionaries can be alternatively handled in one of two following scenarios:
the Application Lifecycle Manager (ALM/app. startup) performs a checkl (matching) among accesses and dictionaries to verify executability of the requested software package;
ALM starts anyway execution of application, dictionary calls labeled as “not present/not available” returns anyway default values, behavior of the executed application can be unpredictable.

Awareness is the basic library of NFC Alias activated at the start up, and verifies presence and capabilities of all elements listed in the system dictionary. As to the static elements, awareness verifies their presence and characteristics, and in case of absence it communicates the system function exceptions (general NFC Alias loader) and must end with a technical message.

As to the dynamic elements, awareness verifies their presence, and in case of absence it connects the specific entry call with a dummy stub, which returns default values, no matter of the parameters delivered by the application.

As far as the system safety is concerned, a trusted third party certificate will be used also as a signing and checking key for exchanging real applications and data between real application and backoffice-proxy or local-proxy. Possible scenarios for use of the digital signature for application safety within NFC Alias project are:
signing the applications, signing the data exchange between client and server;
or exchanging at first ‘touch’ an OTP (One Time Password) token via NFC, with expiry for the application and communication ‘light’ signature.

Two more structural safety scenarios, not directly correlated but all the same important, are to be added:
signing the storage of applications and local data (divided by applications); Or
signing only the application indexes and using tokens or other internal means for application local data segregation.

In FIG. 6, we have represented the NFC Alias client components in accordance with a preferred embodiment of the present invention. The other main part of the NFC Alias system, the server, basically includes the same software components of the Loader, and reproduces its structure, with the exception of the execution engine module and the parser module, which are not necessary for the server. Alternatively, for a greater design economy, the two libraries could be maintained also on the server, leaving them disabled. In addition, in accordance with a further embodiment of the present invention, Proxies and Watch Dog libraries could be added on the server, with the specific aim of attending to the creation of the communication channels passing on between client and back office (Proxies libraries, see the examples referred to in the previous paragraphs, relating to the access to local actuators and/or other remote systems) and to the server internal status consistency check in the long run (Watch Dog library).

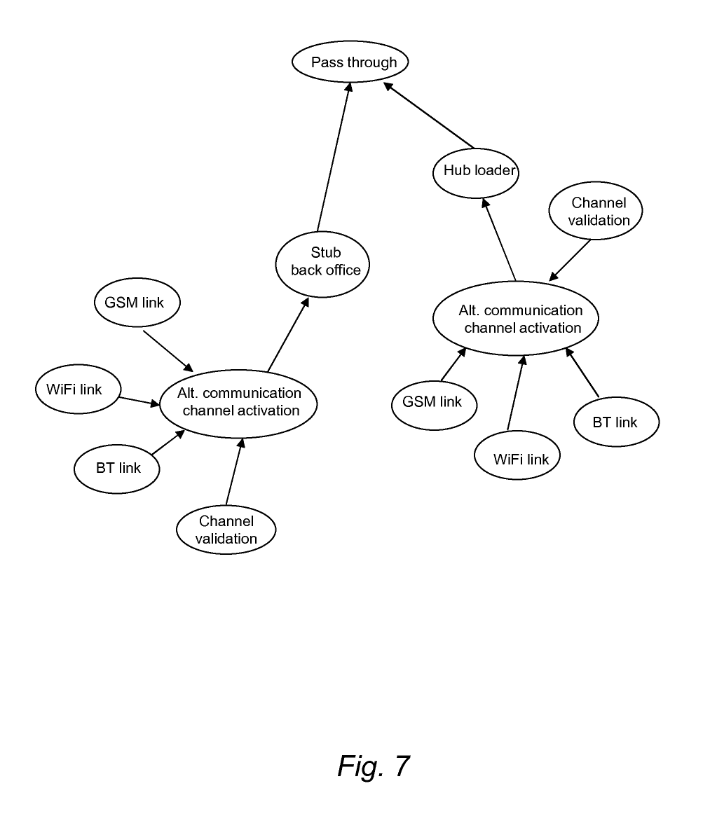

FIG. 7 shows schematically the communication between the NFC Alias Loader and possibly the Back Office. In accordance with a preferred embodiment of the present invention, such communication occurs through the universal server directly (with no intermediate passages). In other words, the application running in the Loader execution engine communicates directly with the backoffice through the server, but without any processing by the server on the communication content. In this way, the server acts as a kind of bridge, that is a passthrough capable of transferring lower level protocols, for example, as it happened with the bridge concept in the layer 2 ISO/OSI model.

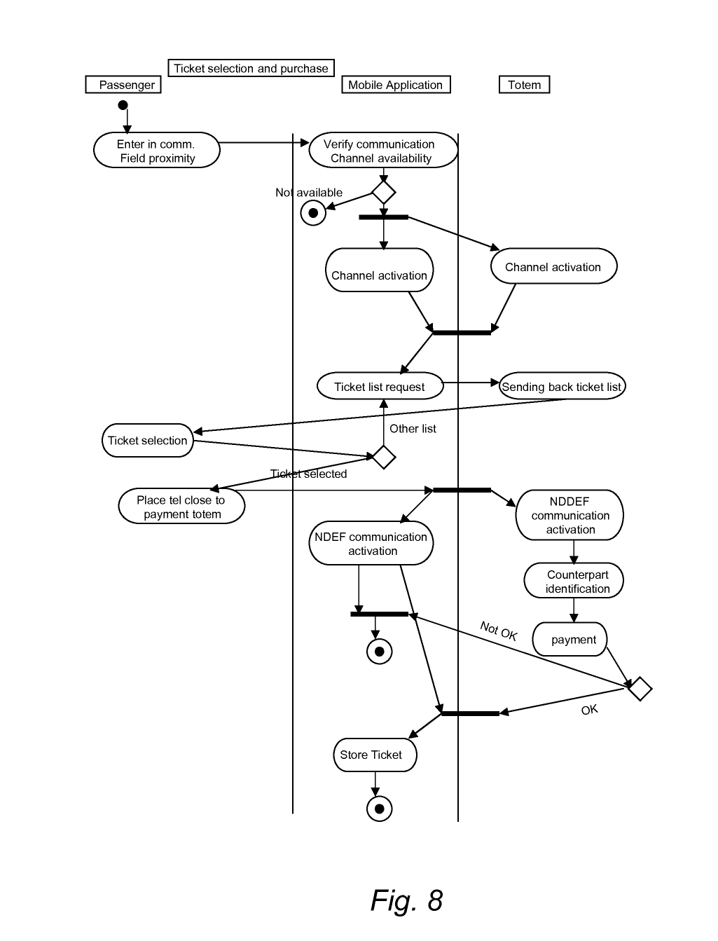

To better understand the functionalities of the present invention, three application examples are reported below, which use the preferred embodiment as described above. FIGS. 8-13 comply with the UML syntax to show the operation flow between universal client 101 and universal server 103 (see FIG. 1). In particular FIGS. 8-10 refer to an application for e.g. railway ticket selling. The application must handle the purchase of the railway ticket, ticket obliteration, ticket validation on the train.

Step 1—Loading, as described previously with reference to FIG. 4

Step 2—Ticket selection. The application selects a secondary communication channel (e.g. BlueTooth (BT), Wifi) with the system at the station, and starts the ticket searching step by using the application menus, or by iteration with a physical tag applied on the train timetable at the station. Then it selects the ticket. A token is loaded on the telephone

Step 3—Purchase. By placing the telephone close to a totem, an interface is established with the payment system via NDEF communication. The token is validated ad purchased. Both steps 2 and 3 are shown in FIG. 8.

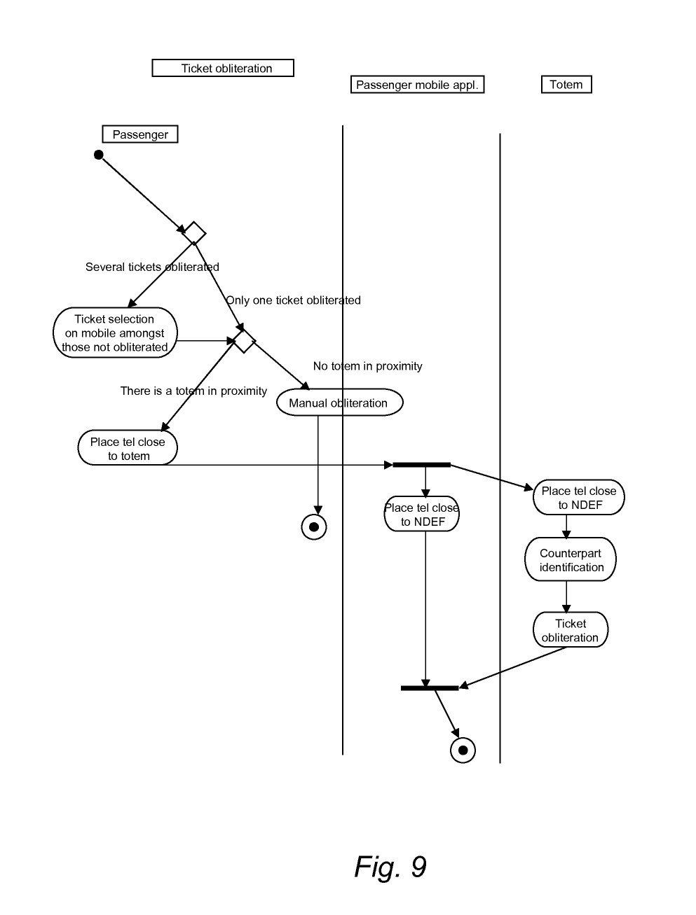

Step 4—Ticket obliteration (see FIG. 9). The user makes a selection amongst its purchased tickets (if he has more than one) by the menu. He places the telephone close to the obliteration totem. The token is validated as obliterated. In case a totem is missing, a manual obliteration is made by an application menu.

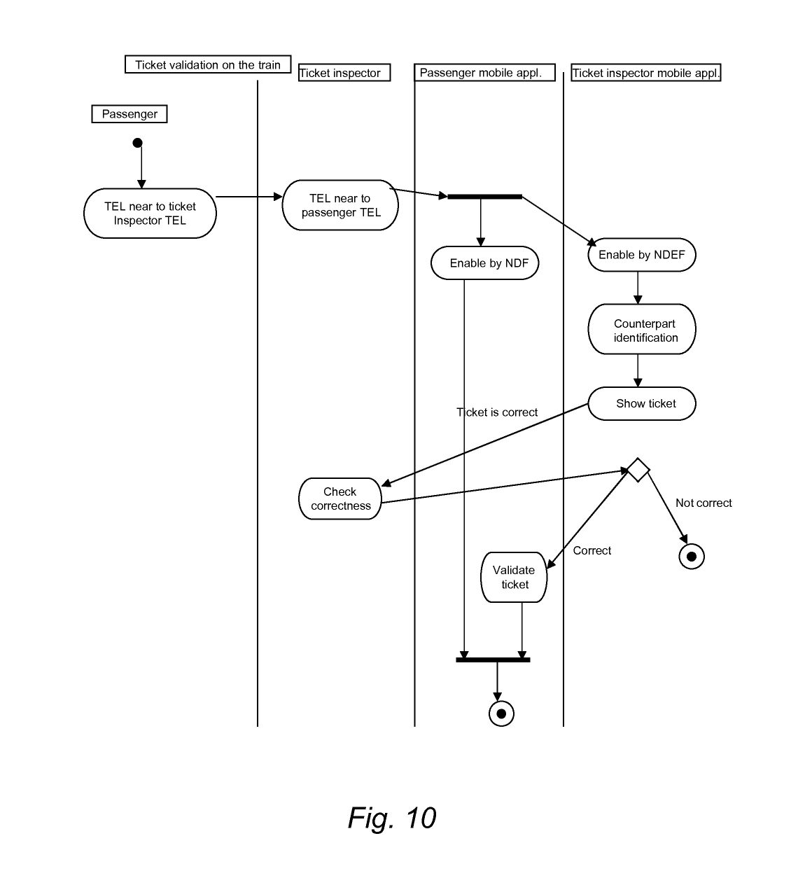

Step 5. Validation on the train (FIG. 10). The ticket inspector and the passenger place their terminals (e.g. mobile phones) close to each other. The application of the ticket inspector terminal verifies that the ticket on the passenger terminal is obliterated, via NDEF communication, shows the details (class, seat, etc,), and validate it upon request by the ticket inspector.

Another implementation example concerns culture contents handling (e.g. music, films, texts). The application is supposed to handle the purchase/downloading of media contents (videos, audios, texts) and their use (exploitation) through, e.g., the telephone.

Step 1—Loading, as described previously with reference to FIG. 4

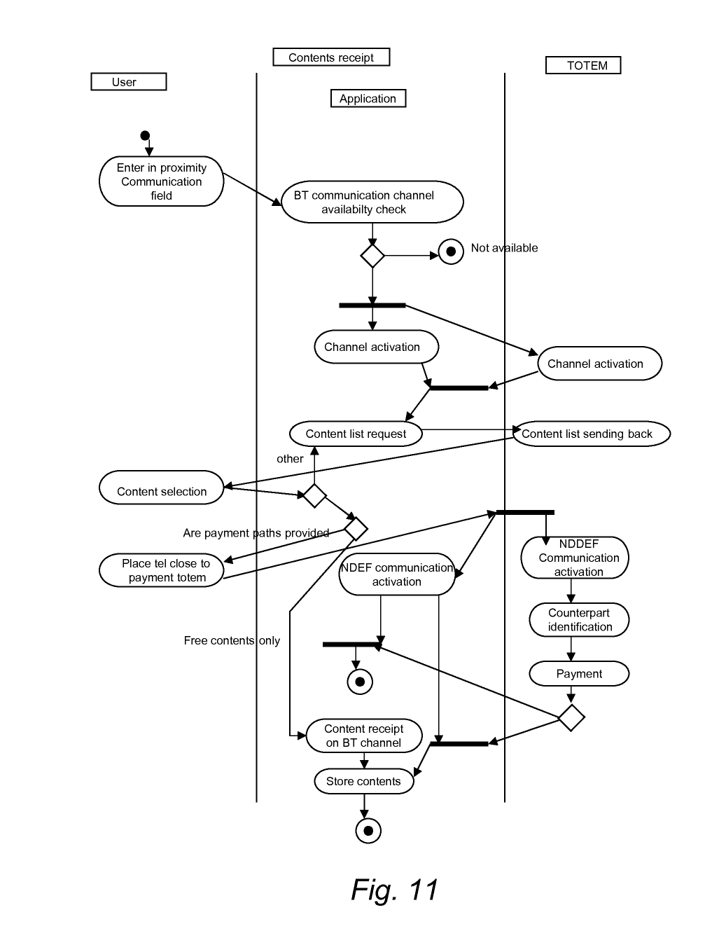

Step 2—Acquisition of the contents (see FIG. 11)
A) Contents selection. The user gets in proximity of a distribution point and the application, on the basis of the telephone characteristics, establishes a BT communication with the distribution point. By interaction with the application, the user selects the contents to be downloaded on this channel.
B) Purchase. By placing the telephone close to a totem, an interface is established with the payment system via NDEF communication, for possible purchasing of contents.
C) Download. Media contents are downloaded on the alternative communication channel (BT).

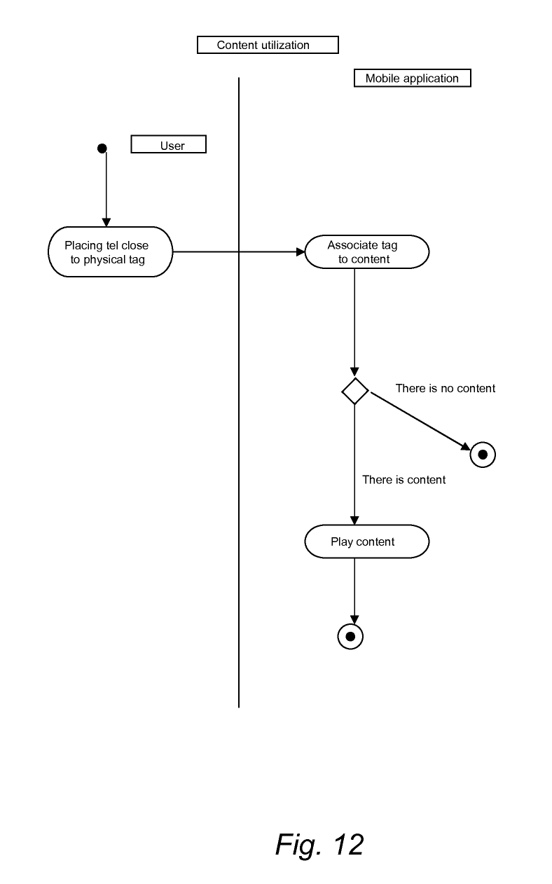

Step 3. Use (see FIG. 12). The user places the telephone close to a passive TAG located near the work the content of which he wants to make use of. The application plays the content.

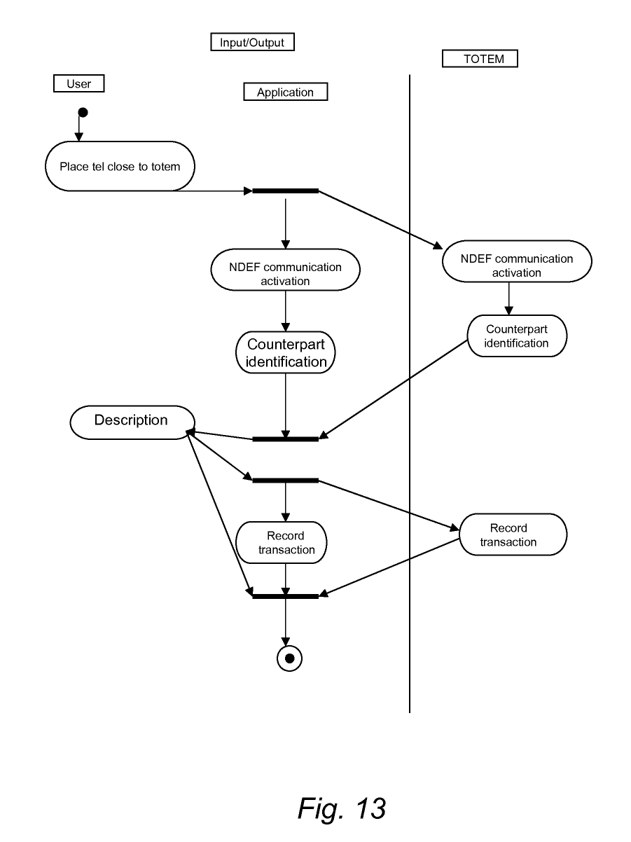

Another possible use is checking the access to a restricted access zone (or even simply access monitored zone). This application does not include any economic transaction, but simply an information exchange with the service provider informative system. The application should allow the user to declare some passage justifications through a cross path, and is shown in FIG. 13.

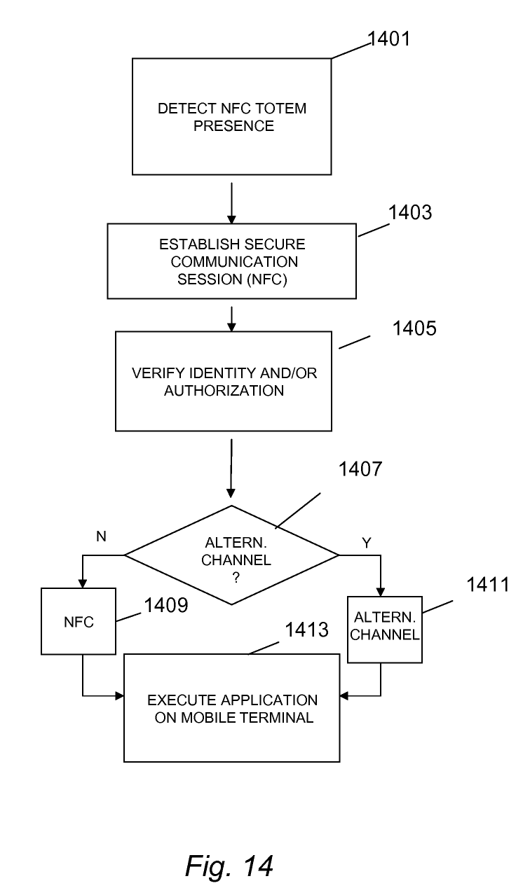

The diagram of FIG. 14 illustrates schematically the step sequence of a method according to a preferred embodiment of the present invention. The method begins at step 1401, in which a mobile terminal equipped with the NFC Alias system detects the presence of a server suitably adapted to this service, also called NCF Totem (and/or vice versa). This detection implies that the distance between the wireless proximity transceiver (e.g. the NFC transceiver) and the analogous server transceiver is shorter than the maximum transmission range of the channel being used (e.g. about 10 cm in the case of NFC Alias). During the present description we had always referred to the case where it is the mobile terminal, with the universal client installed, moving to enter the proximity range of the with the server; it is of course possible the other way round, i.e. the terminal can be fixed and it is the server which moves. Yet another option is that they both move to come into reciprocal contact (i.e. within the proximity communication range). Just as an example we can think of the case where the server must establish a connection with a plurality of terminals in rapid sequence: in such case it could be more efficient moving the server relatively to the terminals. In general we can say that the functions and functionalities of clients and servers can be very similar, sometimes they could be even swapped, as already mentioned with reference to the software structure. What differentiates the client from the server is that the client requests a service and the server provides the service, but it cannot be excluded that a client can operate as server in another occasion. At step 1403, a secure communication session is established between the mobile terminal and the server. During this session (normally at the beginning) the identity is verified of the mobile terminal, to which a certified identification means is associated (see step 1405). For example, the identification means can be the number of a credit card, which enables economic transactions, or else an identification code for accessing a service or a restricted area. At step 1407, the presence of a possible alternative channel for data transmission is verified, and it is determined whether the transmission channel must be changed. This step, as mentioned above, is optional and depends on both the functionalities of the hardware devices and the system architecture. On the basis of the decision outcome, the download is made from the server to the client (i.e. to the mobile terminal) of the application necessary for the mobile terminal to access the NFC Totem services. The download can be performed on the channel already in use for the authentication session (i.e. the NFC channel, in the preferred embodiment) as shown at step 1409, or through an alternative channel (e.g. bluetooth) if this is possible, as at step 1411. When the application has been downloaded on the mobile terminal, it can be executed and supplies the mobile terminal user with an interface to access the NFC Totem services (step 1413).

In practice, the implementation details can be changed and modified in many equivalent ways as far as the described and shown single constructive elements as well as the nature of the indicated materials are concerned, without departing from the adopted solution and therefore remaining within the scope of the protection accorded to the present patent. A person skilled in the art can modify the solution described above in many way, with the aim of complying with local or specific requirements. In particular, it should be clear that, even if implementation details have been given with reference to one or more preferred embodiments, omissions, substitutions or changes of some specific features or steps of the method described can be adopted due to design or manufacturing needs. For example, the hardware structures could take different embodiment or include different modules; with the term computer we include any apparatus (e.g. telephones, palmtop computers) having a processing capability, for execution of software programs or part thereof. The programs can be structured in different way or implemented in any form. In the same way, memories can be of many constructive forms or can be replaced by equivalent entities (not necessarily formed by tangible supports). The programs can be in any form suitable for execution of the related tasks and can be written in any programming language or presented in form of software, firmware or microcode, both in object code and in source code. The programs themselves can be stored on any kind of support, provided that it can be read by a computer; for example, the supports can be: hard disks, removable discks, (e.g. CD-ROM, DVD or Blue Ray Disc), tapes, cartridges, wireless connections, networks, telecommunication waves; for example, the supports can be electronic, magnetic, optical, electromagnetic, mechanical, infrared type or semiconductors. In any case, the solution in accordance with the present invention can be implemented by means of software, hardware (also integrated in a chip or in semiconductor materials) or a hardware and software combination.

1. A method for carrying out electronic transactions by means of client mobile devices capable of establishing communications with a plurality of server devices through a first at least one proximity wireless communication channel, each client mobile device being associated with certified identification means, each server device being associated to the supply of at least one service or good, the method comprising:
detecting presence of a client mobile device, within a predetermined communication distance from a server device of said plurality of server devices;
establishing a secure communication session for carrying out transactions between the client mobile device and the server device;
responsive to the server device authenticating the identity of the client mobile device by means of data associated to the certified identification means, downloading one or more software modules of a software application from the server device to the client mobile device, the application being adapted to handle the supply of the at least one service or good associated to the server device; and
running the software application on the client mobile device, thereby providing the client mobile device user with an interface, by which the supply of the service or good associated to the server device can be requested.

2. The method as claimed in claim 1, wherein the first at least one proximity wireless communication channel includes a Near Field Communication (NFC) protocol based channel, and the secure communication session is carried out according to NFC protocol.

3. The method as claimed in claim 1, wherein the client mobile devices and the server devices are set up for communication by means of at least a second communication channel, the at least second wireless communication channel including one of the following communication protocols: bluetooth, RFID, WiFi, GSM/GPRS/UMTS and the download connection occurs by means of the at least second communication channel.

4. The method as claimed in claim 1, wherein the certified identification means includes association with an electronic payment card.

5. The method as claimed in claim 1, wherein the server device is connected to at least one communication network and the client mobile device authentication includes sending an authorisation request by the server device to a remote system through the communication network, such authorisation request including data associated to the certified identification means.

6. A mobile terminal for establishing communications for carrying out electronic transactions by means of at least one proximity wireless communication channel with a plurality of server devices associated to supplying at least a service or product, the mobile terminal comprising:
a memory area for storing data associated with a certified identification means;
transceiver means for establishing a connection with a proximity-based secure wireless channel with the plurality of server devices, when the mobile terminal enters the communication range of the secure wireless channel with a server device of the plurality of server devices;
transceiver means aimed at exchanging data by means of a large capacity wireless channel with the plurality of server devices, when the mobile terminal enters the communication range of the large capacity wireless channel with a server device of the plurality of server devices;
a memory area for storing a software application downloaded by a server device with which a connection for data exchange has been established, the application being designed to handle the carrying out of electronic transactions for the supply of the at least one service or good associated to the server device;
a processor for running the software application; and
input-output devices for displaying to the mobile terminal user an interface, by which the supply of the service or product associated to the server device can be requested.

7. The mobile terminal of claim 6, wherein the proximity secure wireless channel is the NFC channel.

8. The mobile terminal of claim 6, wherein the large capacity wireless channel includes one of the following communication channels: bluetooth, RFID, WiFi, GSM/GPRS/UMTS.

9. A server system associated to the supply of at least one service or product, capable of establishing communications for carrying out electronic transactions by means of at least one proximity wireless communication channel with a plurality of mobile terminals, the server system comprising:
transceiver means aimed at establishing a connection via a proximity-based secure wireless channel with the plurality of client mobile terminals, when a mobile terminal enters the communication range of the secure wireless channel;
a security module, connectable with a memory area containing identification data associated to a plurality of mobile terminals;
responsive to an authentication request by a mobile terminal entered in the secure wireless channel communication range, processing means aimed at verifying the terminal identity;
a memory area containing a software application adapted to handle the carrying out of electronic transactions for the supply of the at least one service or good associated to the server system;
transceiver means for data exchange via a large capacity wireless channel with the mobile terminal with which a connection has been established via the large capacity wireless channel, for uploading the software application to the mobile terminal; and
a processor for executing the commands received by the mobile terminal by processing the downloaded software application on the mobile terminal.

10. The server system of claim 9, wherein the proximity secure wireless channel is the NFC channel.

11. The server system of claim 9, wherein the large capacity wireless channel includes one of the following communication channels: bluetooth, RFID, WiFi, GSM/GPRS/UMTS.

12. (canceled)

13. A computer program product including computer readable means embodying a computer program for implementing the method for carrying out electronic transactions as claimed in claim 1.

14. A system including one or more components adapted to implement the method for carrying out electronic transactions as claimed in claim 1.

15. A service deployed in a data processing system for implementing the method of claim 1.
